(19) United States
(12) Patent Application Publication
(10) Pub. No.: US 2025/0256367 A1
(43) Pub. Date: Aug. 14, 2025

(54) POSITIONING METHOD, PRESS-FITTING APPARATUS, PIN PROCESSING METHOD, EXPOSURE APPARATUS, AND ARTICLE MANUFACTURING METHOD

(71) Applicant: CANON KABUSHIKI KAISHA, Tokyo (JP)

(72) Inventors: TAKESHI IMAMURA, Tochigi (JP); ISAMU OKUMA, Tokyo (JP); AKIRA YAJIMA, Saitama (JP); SHOZO MAKITA, Tochigi (JP); TSUYOSHI YAMAMOTO, Tochigi (JP); NAOKI FUNABASHI, Tochigi (JP); WATARU YAMAGUCHI, Tochigi (JP); TOMOTAKA ABE, Kanagawa (JP)

(21) Appl. No.: 19/025,622

(22) Filed: Jan. 16, 2025

(30) Foreign Application Priority Data
Feb. 9, 2024 (JP) 2024-018442

(51) Int. Cl. B23P 19/02; B23P 19/12

(52) U.S. Cl. CPC B23P 19/02; B23P 19/12

(57) ABSTRACT

Disclosed is a method for positioning a second member with respect to a first member, including deforming a pin to form an indentation, press-fitting the deformed pin into a hole in the first member; and abutting the second member against the pin, wherein, when abutting the second member, a center position of a deformed area of the pin is closer to the second member than to a central axis of the pin.

### BACKGROUND

### Field

The present disclosure relates to a positioning method, a press-fitting apparatus, a pin processing method, an exposure apparatus, and an article manufacturing method.

### Description of the Related Art

For a manufacturing step in which an article is manufactured by combining a plurality of members, there is a method in which a pin is used to position a second member with respect to a first member, and to fix the relative positions of the first and second members. Japanese Patent Application Laid-Open No. 2007-54937 discusses a pin driving device that automatically press-fits positioning pins into holes.

When a positioning pin is press-fitted into a hole, a pin that has been deformed by being crimped can be used to reduce the possibility of the pin coming out of the hole. This crimping is performed by applying force from the outer periphery of the pin to the center of the pin by using a tool or the like to deform the pin. Here, when the crimped pin is press-fitted into the hole, the pin may tilt. This tilt of the pin changes depending on the conditions under which the pin is crimped. If the tilt direction of the pin is not the desired direction, the second member may not be positioned correctly with respect to the first member.

### SUMMARY

The present disclosure is directed to a positioning method capable of improving the positioning accuracy of a second member with respect to a first member by tilting a pin in a desired direction.

According to an aspect of the present disclosure, a method for positioning a second member with respect to a first member is provided that includes deforming a pin to form an indentation, press-fitting the deformed pin into a hole in the first member; and abutting the second member against the pin, wherein, when abutting the second member, a center position of a deformed area of the pin is closer to the second member than to a central axis of the pin.

Further features of the present disclosure will become apparent from the following description of exemplary embodiments with reference to the attached drawings.

### BRIEF DESCRIPTION OF THE DRAWINGS

FIGS. 1A and 1B are schematic diagrams of a pin press-fitting apparatus according to a first exemplary embodiment.

FIGS. 2A to 2C are schematic diagrams illustrating a state where a second member is positioned with respect to a first member by using a pin.

FIGS. 3A and 3B are schematic diagrams illustrating states where the second member abuts on the first member.

FIGS. 4A to 4C are schematic diagrams of a crimped pin according to the first exemplary embodiment.

FIGS. 5A to 5C illustrate examples of an angle of an indentation (scratch) of a pin.

FIGS. 6A to 6C illustrate examples of tilt of a pin.

FIGS. 7A to 7C illustrate examples of the position of a scratch of a pin in the Z-axis direction.

FIG. 8 is a flowchart of positioning the second member with respect to the first member by using the pin according to the first exemplary embodiment.

FIG. 9 is a schematic diagram of a pin press-fitting apparatus according to a second exemplary embodiment.

FIG. 10 is a flowchart of positioning a second member with respect to a first member by using a pin according to the second exemplary embodiment.

FIGS. 11A to 11C illustrate an example of a crimped pin according to a third exemplary embodiment.

FIG. 12 is a flowchart of positioning a second member with respect to a first member by using a pin according to a fourth exemplary embodiment.

FIG. 13 is a flowchart of an article manufacturing method according to a fifth exemplary embodiment.

### DESCRIPTION OF THE EMBODIMENTS

Embodiments of the present disclosure will be described below with reference to the drawings. The following exemplary embodiments do not limit the recited claims. Although the exemplary embodiments describe a plurality of features, not all of these features are essential to the disclosure, and the exemplary embodiments may be combined in any desired manner. In the drawings, the same reference numbers are used for the same or similar components, and duplicate description may not be repeated, for conciseness.

In the present specification and drawings, directions are indicated utilizing an XYZ coordinate system in which the vertical direction is the Z axis and a horizontal plane perpendicular to the vertical direction is the XY plane, with the axes being orthogonal to each other. When an XYZ coordinate system is indicated in each drawing, that coordinate system shall take precedence.

A specific configuration will be described below for each exemplary embodiment.

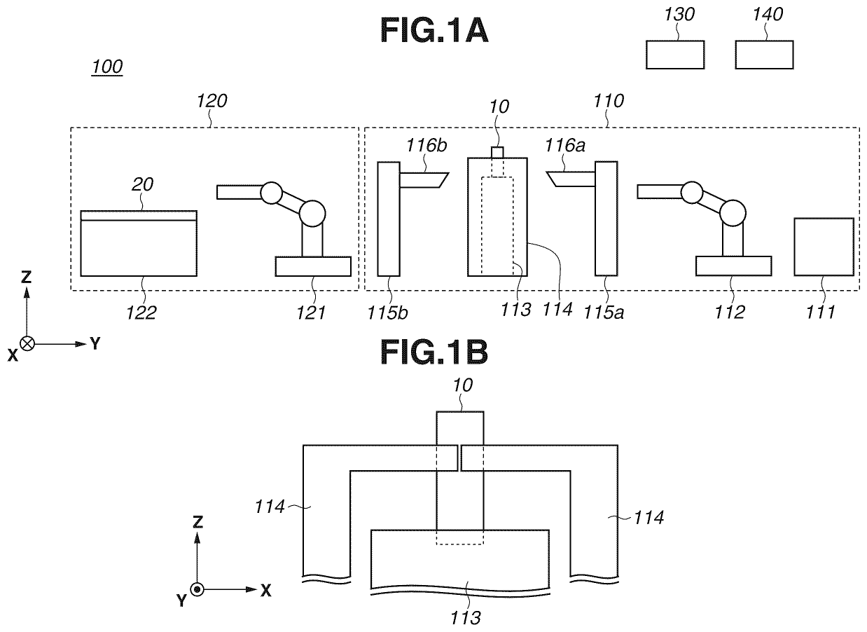

FIG. 1A is a schematic diagram of a pin press-fitting apparatus 100 according to a first exemplary embodiment. As illustrated in FIG. 1A, the pin press-fitting apparatus 100 includes a crimping device 110, a press-fitting device 120, a control unit 130, and a storage unit 140. The control unit 130 controls the components of the crimping device 110 and the press-fitting device 120.

The crimping device 110 includes a supply unit 111, a first transport unit 112, a pin holding unit 113, a pin fixing unit 114, a first drive unit 115a, a first tool 116a, a second drive unit 115b, and a second tool 116b. The first transport unit 112 is, for example, an articulated robot, and is provided at its tip portion with a gripper unit (robot hand) capable of gripping a pin 10 and a rotator unit capable of rotating the pin 10. The supply unit 111 stores a plurality of the pins 10. The plurality of pins 10 may include a plurality of types of pins having different diameters, for example. In a case where the supply unit 111 is to supply the plurality of types of pins, the plurality of types of pins is managed by type. The first transport unit 112 transports, to the pin holding unit 113, a desired pin 10, which has been supplied from the supply unit 111, to be press-fitted into a predetermined hole provided in a first member 20. The desired pin 10 is, for example, a pin having a diameter corresponding to the diameter of the hole into which the pin 10 is to be press-fitted, or a pin of a desired length.

FIG. 1B illustrates a method for holding the pin 10. The pin holding unit 113 holds one end of the pin 10. This holding may be performed, for example, by pinching the pin 10 or by suctioning gas and vacuum-suctioning the pin 10; the holding method is not particularly limited. The height of the pin holding unit 113 can be changed according to the length of the pin 10 to be held, and by changing the height of the pin 10, the position at which the pin 10 is crimped (deformed) can be adjusted. The pin 10 held by the pin holding unit 113 is fixed at its upper portion by the pin fixing unit 114. The pin fixing unit 114 sandwiches the pin 10 to be fixed. In the present exemplary embodiment, applying force to a predetermined region of the pin 10 to deform the pin 10 may be referred to as crimping.

Then, the pin 10, the position of which has been fixed by the pin holding unit 113 and the pin fixing unit 114, is deformed by being crimped at the position between the portion held by the pin holding unit 113 and the portion fixed by the pin fixing unit 114. This crimping is performed by the first tool 116a and the second tool 116b applying force from respective points on the outer periphery of the pin 10 to the center of the pin 10, to deform the pin. Specifically, the crimping is performed by sandwiching the pin 10 between the first tool 116a and the second tool 116b. For the crimping, the first tool 116a is driven by the first drive unit 115a, and the second tool 116b is driven by the second drive unit 115b.

The first tool 116a and the second tool 116b are made of a hard material (e.g., tool steel) capable of crimping the pin 10, and applying force to the pin 10 at their tip portions to create scratches (indentations) as the pin 10 is crimped and deformed. The first tool 116a and the second tool 116b are, for example, cylindrical members cut obliquely with sharpened tips. The first drive unit 115a and the second drive unit 115b each include, for example, an air cylinder. The pin 10 is sandwiched between the first tool 116a and the second tool 116b by the force of the air cylinders, thereby crimping the pin 10. One of the first tool 116a and the second tool 116b may be fixed in position, and only the other may be driven to crimp the pin 10.

The pin 10 that has been deformed by being crimped is press-fitted into the hole provided in the first member 20 by the press-fitting device 120. The press-fitting device 120 includes a second transport unit (press-fitting unit) 121 and a member holding unit 122. The second transport unit 121 transports the pin 10, which has been deformed by being crimped by the crimping device 110, from the crimping device 110, and press-fits the pin 10 by a predetermined amount into the hole provided in the first member 20 held by the member holding unit 122. The member holding unit 122 includes, for example, abutment portions (such as pins or steps) for positioning the first member 20 and fixing portions (such as taps or clamps) for fixing the position of the first member 20. The second transport unit 121 is, for example, an articulated robot, and is provided at its tip portion with a gripper unit capable of gripping the pin 10 and a rotator unit capable of rotating the pin 10. The press-fitting device 120 includes an imaging unit or a sensor, which detects the position of the hole into which the pin 10 is to be press-fitted, and the second transport unit 121 press-fits the pin 10 according to the detected position of the hole. This imaging unit or sensor may be included in the second transport unit 121. In this manner, the pin 10 is press-fitted into the first member 20. The gripper unit may have an elongated shape so that the pin 10 can be press-fitted in a narrow space, for example. Further, the gripper unit may include a structure that acts as a stopper for the pin 10 so that the position at which the pin 10 is gripped does not deviate when the pin 10 is press-fitted. The gripper unit is fixed to an arm of the second transport unit 121 by a fixing unit using an electromagnet, vacuum suction, a screw, or the like.

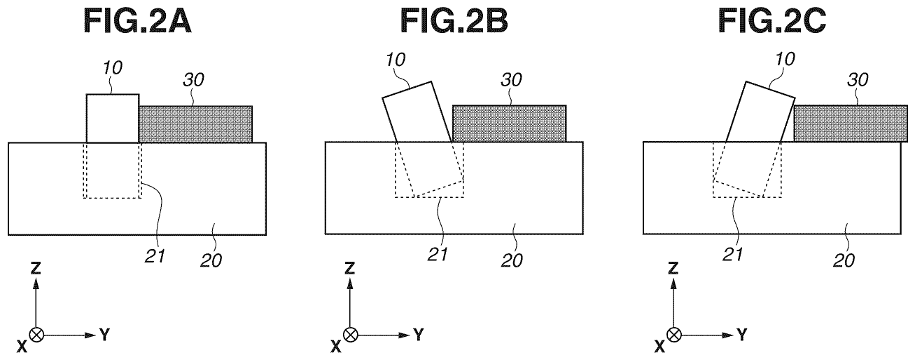

FIGS. 2A, 2B, and 2C are schematic diagrams illustrating states where a second member 30 is positioned with respect to the first member 20 by using the pin 10. The pin 10 is press-fitted into the first member 20, and the second member 30 can be positioned with respect to the first member 20 by the second member 30 abutting on the press-fitted pin 10.

Then, by fixing the relative positions of the first member 20 and the positioned second member 30, the second member 30 can be fixed at a desired position.

FIG. 2A is a diagram illustrating a state where the pin 10 press-fitted into a hole 21 provided in the first member 20 does not tilt. A tolerance is set for each of the pin 10 and the hole 21. The pin 10 has a shape error within a tolerance range, and the hole 21 also has a shape error within the tolerance range. When the difference between the diameter of the pin 10 and the diameter of the hole 21 is small, the pin 10 press-fitted into the hole 21 does not tilt. In such a case, the second member 30 is correctly positioned with respect to the first member 20.

FIG. 2B is a diagram illustrating a state where the pin 10 press-fitted into the hole 21 provided in the first member 20 tilts toward the side opposite to the side on which the second member 30 abuts (the −Y direction side). As illustrated in FIG. 2B, the pin 10 press-fitted into the hole 21 may tilt due to a shape error within the tolerance range of the pin 10 and a shape error within the tolerance range of the hole 21. In the example of FIG. 2B, the pin 10 tilts toward the side opposite to the side on which the second member 30 abuts, and therefore the pin 10 does not tilt toward the side on which the pin 10 abuts (the +Y direction side) after abutting. Therefore, in such a case, the positioning of the second member 30 with respect to the first member 20 will result in a deviation from the desired position, more than when the first member 10 and the second member 30 do not tilt, as in FIG. 2A, but the relative positions of the first member 20 and the second member 30 do not change after the second member 30 abuts. Thus, the positioning is relatively accurate.

FIG. 2C is a diagram illustrating a state where the pin 10 press-fitted into the hole 21 provided in the first member 20 tilts towards the side on which the second member 30 abuts (the +Y direction side). In FIG. 2C, as in FIG. 2B, the pin 10 press-fitted into the hole 21 tilts due to a shape error within the tolerance range of the pin 10 and a shape error within the tolerance range of the hole 21. In the example of FIG. 2C, the pin 10 tilts toward the side on which the second member 30 abuts, and therefore the pin 10 may tilt toward the side opposite to the side on which the pin 10 abuts (the −Y direction side) after abutting. Therefore, after the second member 30 abuts on the first member 20, the relative positions of the first member 20 and the second member 30 change, and the positioning is not accurate.

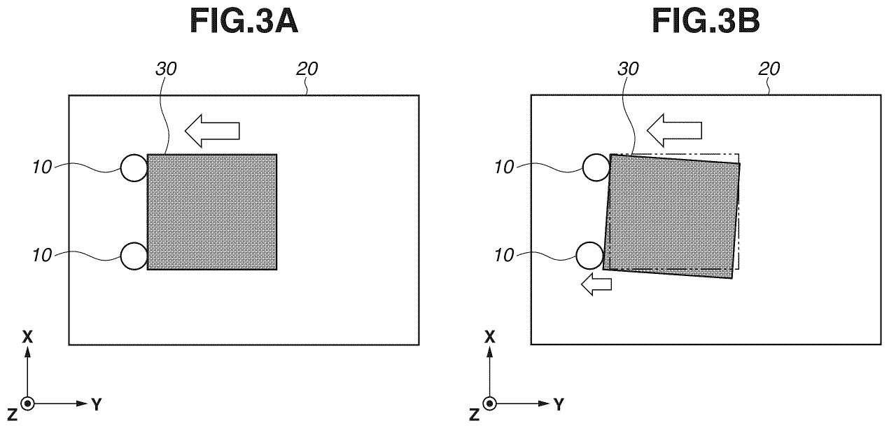

FIGS. 3A and 3B are schematic diagrams illustrating states where the second member 30 abuts on the first member 20. As illustrated in FIG. 3, a plurality of the pins 10 may be press-fitted into the first member 20, and the second member 30 may abut, i.e. butt on, each of the plurality of press-fitted pins 10, thereby positioning the second member 30 with respect to the first member 20. For example, when the plurality of pins 10 are in the state illustrated in FIG. 2A, the positions of the plurality of pins 10 do not move after abutting, so that the second member 30 is correctly positioned at a desired position. When the plurality of pins 10 is in the state illustrated in FIG. 2B and has the similar amount and direction of tilt, the tilt of the pins 10 may cause the position of the second member 30 to deviate from the desired position. However, since the positions of the plurality of pins 10 do not move after abutting, the second member 30 is correctly positioned as illustrated in FIG. 3A.

Here, when the plurality of pins 10 are in the state illustrated in FIG. 2C, the positions of the plurality of pins 10 may move after the second member 30 abuts. Since this movement of the pins 10 does not always occur, one pin 10 may not move, while the other pin 10 may move and tilt in the opposite direction to the abutting side. In such a case, the second member 30 is positioned at an angle with respect to the first member 20 as illustrated in FIG. 3B, and therefore the second member 30 is not positioned correctly.

Accordingly, to correctly position the second member 30 with respect to the first member 20, the pin 10 should not tilt in a desired direction (toward the side opposite to the side on which the pin 10 abuts). However, as described above, the pin 10 may tilt due to the tolerance between the pin 10 and the hole 21.

Therefore, to correctly position the second member 30 with respect to the first member 20, the pin 10 tilts in a desired direction (toward the side opposite to the side on which the second member 30 abuts).

The tilt of the pin 10 changes depending on the conditions when the pin 10 is crimped. However, in conventional pin processing methods (crimping methods), the pin 10 is not crimped under conditions that takes into account the direction in which the pin 10 would tilt after being press-fitted, so that the pin 10 could sometimes tilt in a direction other than a desired direction. For example, conventionally, the pin 10 is crimped at positions near where its diameter is greatest. In that case, a worker needs to adjust the position of the second member 30 by adjusting the tilt of the pin 10 with a tool or the like. A plurality of the positioning pins 10 may be press-fitted into one first member 20. In such a case, the worker needs to adjust the tilt of the plurality of pins 10 as appropriate, which takes time for the adjustment.

Therefore, in the present exemplary embodiment, the pin 10 is crimped under conditions that allow the pin 10 to tilt in a desired direction. Since the direction in which the pin 10 tilts depends on the crimping position at which the pin 10 is crimped, in the present exemplary embodiment, the pin 10 is crimped at the position on the side of the pin 10 on which the second member 30 abuts so that the pin 10 tilts in the desired direction (toward the side opposite to the side on which the second member 30 abuts).

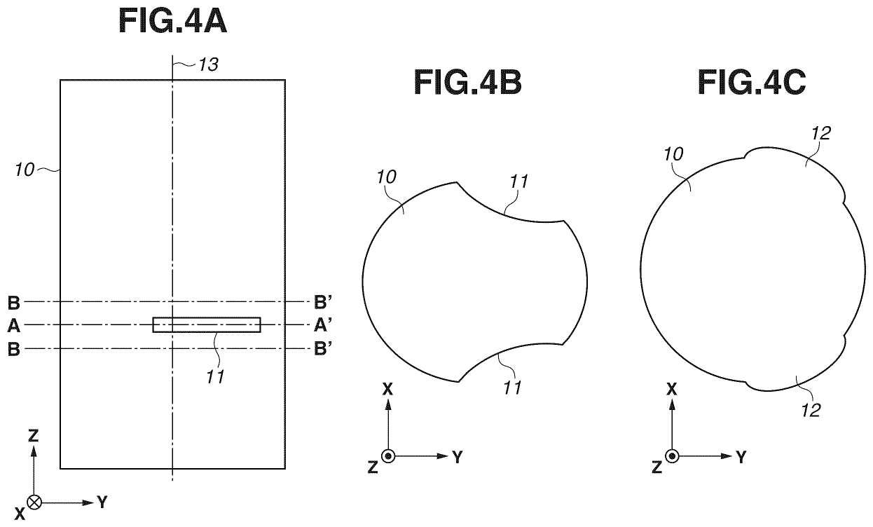

FIGS. 4A, 4B, and 4C are schematic diagrams of a crimped pin 10 according to the present exemplary embodiment. In the present exemplary embodiment, as illustrated in FIG. 4A, the first tool 116a and the second tool 116b crimp the pin 10 while making a scratch 11 on the pin 10, centered at a position deviating from a central axis 13 of the pin 10, with the central axis being formed along the longitudinal direction of the pin 10. Then, the pin 10 is press-fitted so that the center positions in the longitudinal direction of the deformed regions (scratches 11, dents) of the pin 10 are closer to the side on which the second member 30 abuts than the central axis 13 is. In this case, in a cross section A-A′, which corresponds to a position in the Z-axis direction coincides with the positions of the scratches 11, the places of the scratches 11 are recessed, as illustrated in FIG. 4B. Then, in a cross section B-B′, which corresponds to a position in the Z-axis direction deviating from the positions of the scratches 11, regions 12 located on the +Z and −Z direction sides of the scratches 11 extend, i.e. bulge, as illustrated in FIG. 4C. The deformation (bulge) of the regions 12 increases the resistance between the pin 10 and an object (hole 21) into which the pin 10 is press-fitted, making it difficult for the pin 10 to be removed from the hole 21. The central axis 13 of the pin 10 is, for example, the central axis of the pin 10 before the pin 10 is deformed (before being crimped).

In the example of FIGS. 4A to 4C, the scratches 11 are made on the +Y direction side of the central axis 13. Therefore, when the pin 10 is press-fitted into the first member 20, the extension/bulge of the regions 12 causes greater resistance between the pin 10 and the first member 20 (hole 21) on the +Y direction side of the pin 10 than on the −Y direction side. Therefore, the +Y direction side of the pin 10 is less likely to be press-fitted into the first member 20, and the −Y direction side of the pin 10 is more likely to be press-fitted into the first member 20. As a result, the length of the pin 10 to be press-fitted on the −Y direction side is longer than that on the +Y direction side, and the pin 10 tilts toward the −Y direction side, resulting in the state illustrated in FIG. 2B. In this manner, in the present exemplary embodiment, the crimping position is set to a position on the side of the pin 10 on which the second member 30 abuts, so that the pin 10 can tilt toward the opposite side to the direction in which the second member 30 abuts, and the pin 10 can correctly position the second member 30 with respect to the first member 20.

The position(s) (position(s) in the Y-axis direction) at which the pin 10 is crimped may be adjusted by adjusting the positions of the first tool 116a and the second tool 116b in the Y-axis direction, by using the first drive unit 115a and the second drive unit 115b. Alternatively, the position may be adjusted by adjusting the position of the pin 10 in the Y-axis direction when the pin 10 is crimped by a drive mechanism included in the pin holding unit 113.

The tilt direction of the pin 10 may be set to a desired direction, and/or the tilt amount of the pin 10 may set to a desired amount. For example, even when a plurality of the pins 10 tilt in a desired direction as illustrated in FIG. 2B, if the plurality of pins 10 have different amounts of tilt, the second member 30 may be positioned at an angle with respect to the first member 20, as illustrated in FIG. 3B. As a result, the second member 30 is not positioned correctly. The amount of tilt of the pin 10 depends on the angle between the first tool 116a and the second tool 116b, the crimping position (crimping height) of the pin 10 in the Z-axis direction, and the strength of the crimping force (the size of the scratch 11).

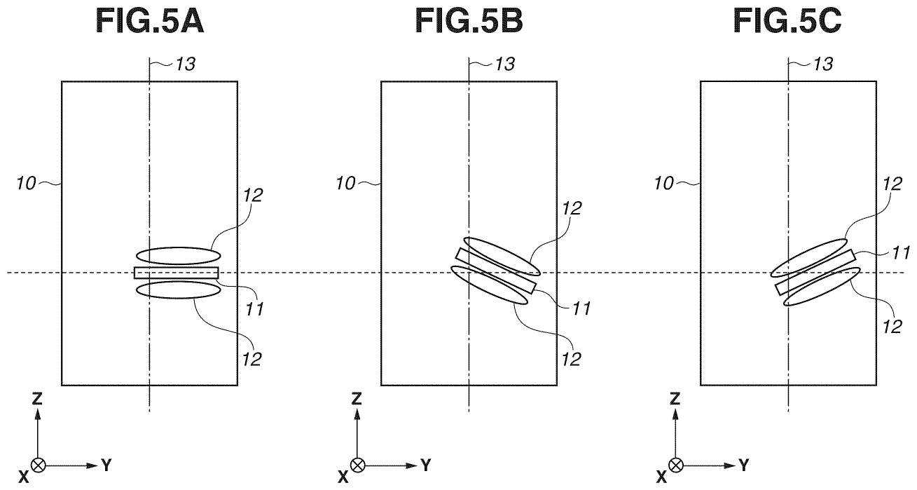

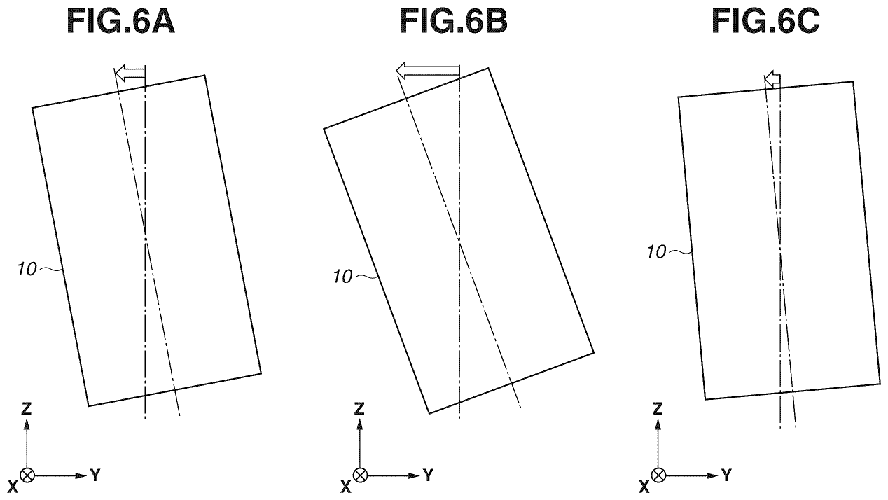

The relationship between the amount of tilt of the pin 10 and the angle between the first tool 116a and the second tool 116b is described with reference to FIGS. 5A, 5B, 5C, 6A, 6B, and 6C. FIGS. 5A, 5B, and 5C illustrate examples of the angle of the scratch 11 of the pin 10. FIGS. 6A, 6B, and 6C illustrate examples of the amount of tilt of the pin 10.

FIG. 5A illustrates an example in which the pin 10 is crimped without inclining the first tool 116a and the second tool 116b, and the scratch 11 does not tilt with respect to the Y axis. FIG. 5B illustrates an example in which the pin 10 is crimped by inclining the first tool 116a and the second tool 116b, and the +Y direction side of the scratch 11 is closer to the −Z direction side than the −Y direction side of the scratch 11 is. FIG. 5C illustrates an example in which the pin 10 is crimped by inclining the first tool 116a and the second tool 116b, and the −Y direction side of the scratch 11 is closer to the −Z direction side than the +Y direction side of the scratch 11 is.

When the pin 10 is crimped as illustrated in FIG. 5A, the pin 10 tilts toward the −Y direction side, as illustrated in FIG. 6A, due to the bulge of the regions 12. When the pin 10 is crimped as illustrated in FIG. 5B, the +Y direction ends of the regions 12 are closer to the −Z direction side than when the pin 10 is crimped as illustrated in FIG. 5A, and therefore resistance caused by the regions 12 when the pin 10 is press-fitted into the first member 20 occurs at an early stage of the press-fitting. As a result, as illustrated in FIG. 6B, the pin 10 tilts toward the −Y direction side, further than in FIG. 6A. When the pin 10 is crimped as illustrated in FIG. 5C, the +Y direction ends of the regions 12 are closer to the +Z direction side than when the pin 10 is crimped as illustrated in FIG. 5A, and therefore resistance caused by the regions 12 when the pin 10 is press-fitted into the first member 20 occurs at a later stage of the press-fitting. As a result, as illustrated in FIG. 6C, the pin 10 is tilted less than in FIG. 6A. In this manner, by adjusting the angle of the scratches 11, that is, the angle between the first tool 116a and the second tool 116b, the amount of tilt of the pin 10 can be adjusted. The angles of the first tool 116a and the second tool 116b are adjusted, for example, by the first drive unit 115a and the second drive unit 115b rotating the tools about the central axes (axes in the longitudinal direction) of the first tool 116a and the second tool 116b, respectively. The tilt of the pin 10 is adjusted so that the central axis 13 tilts by, for example, about 30 μm or less.

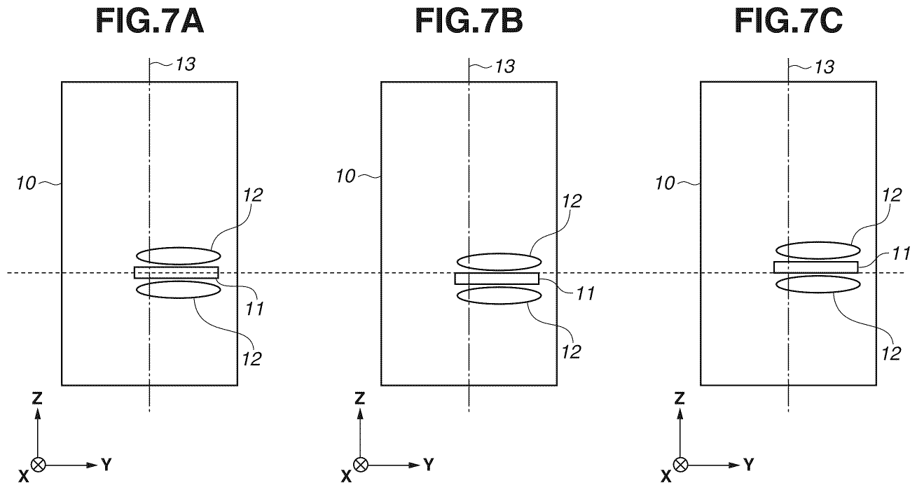

The relationship between the amount of tilt of the pin 10 and the crimping position (crimping height) of the pin 10 in the Z-axis direction will be described with reference to FIGS. 7A, 7B, and 7C. FIGS. 7A, 7B, and 7C illustrate examples of the position of the scratch 11 of the pin 10 in the Z-axis direction.

FIG. 7A illustrates an example in which the pin 10 is crimped without adjusting the positions of the first tool 116a and the second tool 116b in the Z-axis direction. FIG. 7B illustrates an example in which the positions of the first tool 116a and the second tool 116b in the Z-axis direction are adjusted toward the −Z direction side further than in the case of FIG. 7A to crimp the pin 10, and the scratch 11 is on the −Z direction side. FIG. 7C illustrates an example in which the positions of the first tool 116a and the second tool 116b in the Z-axis direction are adjusted toward the +Z direction side further than in the case of FIG. 7A to crimp the pin 10, and the scratch 11 is on the +Z direction side.

When the pin 10 is crimped as illustrated in FIG. 7A, the pin 10 tilts toward the −Y direction side as illustrated in FIG. 6A due to the bulge of the regions 12. When the pin 10 is crimped as illustrated in FIG. 7B, the regions 12 are closer to the −Z direction side than when the pin 10 is crimped as illustrated in FIG. 7A, and therefore resistance caused by the regions 12 when the pin 10 is press-fitted into the first member 20 occurs at an early stage of the press-fitting.

As a result, as illustrated in FIG. 6B, the pin 10 tilts toward the −Y direction side, further than in FIG. 6A. When the pin 10 is crimped as illustrated in FIG. 7C, the regions 12 are closer to the +Z direction side than when the pin 10 is crimped as illustrated in FIG. 7A, and therefore resistance caused by the regions 12 when the pin 10 is press-fitted into the first member 20 occurs at a later stage of the press-fitting. As a result, as illustrated in FIG. 6C, the pin 10 is less tilted than in FIG. 6A. In this manner, by adjusting the position of the scratches 11 in the Z-axis direction, that is, the crimping position (crimping height) of the pin 10 in the Z-axis direction, the amount of tilt of the pin 10 can be adjusted. The crimping position (crimping height) may be adjusted by adjusting the height position of the pin holding unit 113, for example. Alternatively, the position may be adjusted by adjusting the positions of the first tool 116a and the second tool 116b in the Z-axis direction by using the first drive unit 115a and the second drive unit 115b.

The relationship between the amount of tilt of the pin 10 and the strength of the crimping force (the size of the scratch 11) will be described. If a large crimping force is applied, the scratch 11 becomes correspondingly large and the/bulge of the regions 12 also becomes large. This increases the resistance caused by the regions 12 when the pin 10 is press-fitted into the first member 20. Therefore, by enhancing (increasing) the strength of the crimping force, the size of the scratch 11 and the amount of tilt of the pin 10 increases. When each tool is driven by an air cylinder, the strength of the crimping force can be adjusted by adjusting the air pressure.

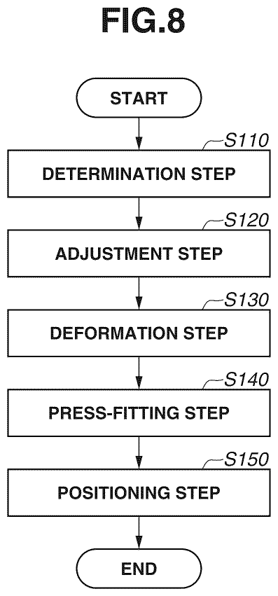

FIG. 8 is a flowchart of positioning the second member 30 with respect to the first member 20 by using the pin 10 according to the present exemplary embodiment. In step S110, the control unit 130 determines conditions for crimping the pin 10. This determination is made by determining, based on the direction in which the second member 30 abuts, conditions for achieving a desired tilt direction and a desired amount of tilt after the pin 10 is press-fitted into the first member 20. The conditions include, for example, at least one of a position at which the pin 10 is crimped (Y-axis direction, Z-axis direction), an angle of the tool for crimping, and a strength of force for crimping. For example, if pins have the same shape but differ in hardness due to differences in materials, different strengths of force for crimping each of the pins is to be applied. The condition of the position (Y-axis direction, Z-axis direction) at which the pin 10 is crimped corresponds to a condition of a position of the tool (Y-axis direction, Z-axis direction) when the pin 10 is crimped or a condition of a position of the pin 10, i.e., a position of a predetermined region to which force is applied from the tool. Further, the angle of the tool for crimping is synonymous with an angle of a predetermined region to which force is applied from the tool. The determination in the determination step may be made by the control unit 130 based on design information (including, for example, information on a direction in which the second member 30 abuts) stored in the storage unit 140. Alternatively, the control unit 130 may make the determination based on condition information input in advance by a user and stored in the storage unit 140.

Such information may be input by the user using, for example, an input device and a display device.

The input device is a device for inputting characters and data, and includes various types of keyboards, mice, and touch panels. The display device is a device for displaying information necessary for operations, processing results, and the like, and corresponds to a cathode ray tube (CRT) or liquid crystal monitor. Alternatively, the information may be input from the user through communication from another information processing apparatus.

Based on the conditions determined in the determination step, the control unit 130 controls to adjust at least one of the position of the pin 10 and the tool settings (angle, position, strength of crimping force) in step S120. After the position and the settings have been made, the pin 10 is crimped, i.e. deformed, in step S130. Then, the pin 10 that has been crimped in such deformation step is press-fitted into the first member 20 in step S140. In this press-fitting step, due to a difference in shape between the pin 10 and the hole 21 into which the pin 10 is to be press-fitted, the pin 10 may not be press-fitted normally, since torque detected in the second transport unit 121 may indicate an abnormal value. In this case, the control unit 130 may cancel the press-fitting, and perform the determination step, the adjustment step, and the deformation step again for another pin, and then perform the press-fitting step. The abnormal pin 10 for which the press-fitting has been canceled is transported, for example, to a box for disposal. Further, if the press-fitting of the pin 10 repeatedly fails, deformation or wear may have occurred in the second transport unit 121. In this case, a replacement unit may replace the gripper unit of the second transport unit 121.

In the press-fitting step, the control unit 130 controls the rotation of the pin 10 about the central axis 13 when the second transport unit 121 transports the pin 10 so that the pin 10 tilts in a desired direction. This control is performed based on the design information (including, for example, information on a direction in which the second member 30 abuts) stored in the storage unit 140. Specifically, this control is performed according to the direction in which the second member 30 abuts and the positions of regions in which the pin 10 is deformed by the tools. In the press-fitting step, the position and angle at which the pin 10 is press-fitted are also controlled.

The second member 30 abuts on the pin 10 that is press-fitted into the hole of the first member 20 in the press-fitting step, thereby positioning the second member 30 with respect to the first member 20 (positioning step, step S150). This positioning step may be performed after the press-fitting of a predetermined number of pins 10 is completed.

Here, if a program relating to the crimping conditions and adjustment for each pin has been provided in advance by the user, the determination step may not be performed, and the adjustment step and the deformation step may be performed in accordance with the program. In addition, after the press-fitting step, a determination step may be performed in which the pin 10 is pulled in a direction to be pulled out from the first member 20 with a predetermined force to check whether the press-fitting has been performed correctly, and if the pin is pulled out, it is determined that the press-fitting has not been performed correctly, and otherwise, that the press-fitting has been performed correctly.

The determination step and the adjustment step may not be performed individually for all of the pins 10. For example, if the pins 10 are of the same type, they may be adjusted in the adjustment step to the conditions determined in the determination step initially, and the determination step and adjustment step may not be performed while the same type of the pins 10 are crimped.

Further, all of the conditions may not be changed, and a configuration may be adopted in which the angle of the tool (the angle of the scratch 11) is set to a constant value and other parameters are determined and adjusted.

In this manner, in the present exemplary embodiment, the tilt of the pin 10 used to position the second member 30 with respect to the first member 20 when the pin 10 is press-fitted into the first member 20 is adjusted by adjusting the conditions for crimping the pin 10. Therefore, the tilt direction and amount of tilt of the pin 10 can be set to a desired direction and amount, respectively, and the accuracy of positioning the second member 30 with respect to the first member 20 by using the pin 10 can be improved.

Further, the moving speeds of the first tool 116a and the second tool 116b when the first tool 116a and the second tool 116b crimp (sandwich) the pin 10 may also be adjusted as conditions for crimping the pin 10.

The control unit 130 includes a processing unit, a bus, a read only memory (ROM), a random access memory (RAM), and a storage device, and each of the components functions according to a program. The processing unit is a processing device that performs calculations for control according to a program and controls each of the components connected to the bus. This processing unit can be configured by a central processing unit (CPU), a programmable logic device (PLD) such as a field programmable gate array (FPGA), an application specific integrated circuit (ASIC), a computer with an embedded program, or a combination of all or some of these. The ROM is a memory dedicated to reading data, and stores programs and data. The RAM is a memory for reading and writing data, and is used for storing programs and data. The RAM is used for temporarily storing data such as the results of calculations by the CPU. The storage device is also used to store programs and data. The storage device is also used as a temporary storage area for data and programs of an operating system (OS) of the control unit 130. Although the data input/output of the storage device is slower than that of the RAM, the storage device is capable of storing a large amount of data. The storage device is desirably a non-volatile storage device capable of storing data as permanent data to allow the stored data to be referred to for a long period of time. The storage device mainly includes a magnetic storage device (HDD) or a solid state drive (SSD), but may also be a device that reads and writes data by loading an external medium such as a compact disc (CD), a digital versatile disc (DVD), and a memory card. The control unit 130 may be configured separately from the other parts of the pin press-fitting apparatus 100 (in a separate housing).

Here, in the present exemplary embodiment, an example has been described in which the first transport unit 112 and the second transport unit 121 are different from each other. However, they may be provided in a single transport unit. Further, in the present exemplary embodiment, an example has been described in which the control unit 130 controls both the crimping device 110 and the press-fitting device 120. However, each of them may include a control unit. The determination step may be performed by another information processing apparatus instead of the control unit 130. In addition, in the present exemplary embodiment, an example has been described in which the first drive unit 115a and the second drive unit 115b are separate from each other. However, they may be a single drive unit. Further, in the present exemplary embodiment, an example has been described in which the pin 10 is crimped while the pin holding unit 113 holds the pin 10. However, the pin 10 may be crimped while being gripped by the first transport unit 112. Further, the pin 10 may be held (gripped) by a same holding unit (transport unit) from the deformation step to the press-fitting step to deform and press-fit the pin 10.

In this manner, the pin 10 may be grasped at a desired rotation angle about the central axis 13, for grasping at positions of the regions to be deformed in the deformation step.

The positioning of the second member 30 with respect to the first member 20 by using the pin 10 according to the present exemplary embodiment is used for positioning between members in a device for processing substrates such as semiconductor wafers and glass plates, for example. Examples of such a device include a projection exposure apparatus, a drawing apparatus, an imprint apparatus, a planarization apparatus, an ion implantation apparatus, a development apparatus, an etching apparatus, a film formation apparatus, an annealing apparatus, a sputtering apparatus, and a deposition apparatus. In particular, the accuracy of positioning is important for apparatuses including an optical system. For example, an exposure apparatus uses a plurality of the positioning pins 10 for positioning members. In a case where a plurality of the pins 10 are used, the time to correct the tilt directions of the pins 10 can be significantly reduced by using the pins 10 according to the present exemplary embodiment. For example, the exposure apparatus includes a first member 20 and a second member 30, the second member 30 is in contact with the pin 10 press-fitted into a hole provided in the first member 20, and the pin 10 has a scratch (indentation) 11. As a result of the scratch 11 being made, regions of the pin 10 near the extension/bulges of the scratch 11. The center positions in the longitudinal direction of the extending/bulging regions of the pin 10 are closer to the side where the second member 30 is in contact than the central axis 13 of the pin 10 is.

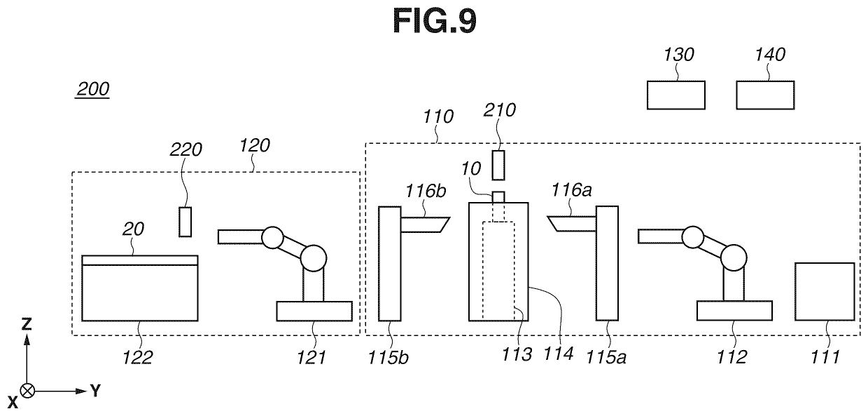

A second exemplary embodiment differs from the first exemplary embodiment in method of determining conditions for crimping the pin 10. FIG. 9 is a schematic diagram of a pin press-fitting apparatus 200 according to the present exemplary embodiment. The pin press-fitting apparatus 200 includes a pin measurement unit 210 configured to measure the shape of the pin 10, and a hole measurement unit 220 configured to measure the shape of a hole into which the pin 10 is to be press-fitted. As the pin measurement unit 210 and the hole measurement unit 220, for example, a sensor configured to measure the shape of an object by image capture, or a sensor configured to measure the shape of an object by using a laser may be used. Further, the pin measurement unit 210 may be an optical micrometer. In this case, the pin 10 is inserted into the pin measurement unit 210 by the first transport unit 112 to measure the shape of the pin 10. Information on the shape of the pin 10 or hole to be measured is, for example, information on the diameter and roundness. The information on the roundness also includes information on the flexure of the pin 10 and the curvature of the hole.

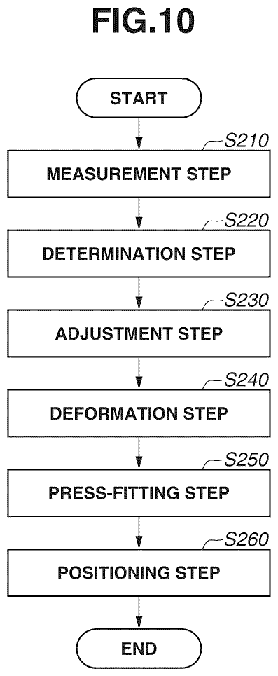

FIG. 10 is a flowchart of positioning the second member 30 with respect to the first member 20 by using the pin 10 according to the present exemplary embodiment. The shape of the pin 10 and the shape of the hole into which the pin 10 is to be press-fitted are measured by the pin measurement unit 210 and the hole measurement unit 220 in step S210. The control unit 130 then determines conditions for crimping the pin 10 in step S220. This determination is made by determining, based on the results of the measurement in the measurement step and the direction in which the second member 30 abuts, conditions for achieving a desired tilt direction and a desired amount of tilt after the pin 10 is press-fitted into the first member 20.

In the measurement of step 210, for example, when the diameter of the pin 10 is small and the diameter of the hole is large, the conditions for crimping are determined to increase the resistance between the pin 10 and the first member 20, specifically to increase the extension/bulge of the regions 12. For example, the strength of force for crimping is enhanced to increase the extension/bulge of the regions 12. In such a case, the pin 10 may significantly tilt, and accordingly, adjustment is made to reduce the amount of tilt based on the measurement results. For example, the pin 10 is crimped so that resistance caused by the extension/bulge of the regions 12 increases at a later stage of the press-fitting. Additionally, the rotation of the pin 10 about the central axis 13 may be adjusted depending on the roundness. Further, in the measurement step, in a case where the pin 10 is bent or the hole is curved, the pin 10 will tilt due to these shapes, and therefore, the conditions for crimping are determined taking into account the tilt direction and amount of tilt of the pin 10 tilting due to the shapes of the pin 10 and the hole. The control unit 130 determines the conditions for crimping based on, for example, a table or a formula that indicates the relationship between the measurement results of the pin 10, the measurement results of the hole, and the amount of tilt when the pin 10 is press-fitted.

The conditions include, for example, at least one of the position where the pin 10 is crimped (Y-axis direction, Z-axis direction), the angle of the tool for crimping, and the strength of force for crimping. The condition of the position (Y-axis direction, Z-axis direction) at which the pin 10 is crimped is synonymous with a condition of a position of the tool (Y-axis direction, Z-axis direction) when the pin 10 is crimped or a condition of a position of the pin 10, in other words, a position of a predetermined region to which force is applied from the tool. Further, the angle of the tool for crimping is synonymous with an angle of a predetermined region to which force is applied from the tool. The determination in the determination step may be made by the control unit 130 based on design information (including, for example, information on a direction in which the second member 30 abuts) stored in the storage unit 140. Alternatively, the control unit 130 may make the determination based on condition information input in advance by a user and stored in the storage unit 140.

Based on the conditions determined in the determination step, the control unit 130 controls to adjust at least one of the position of the pin 10 and the tool settings (angle, position, strength of force for crimping) in step S230. In the state where the position and the settings have been made in the adjustment of step S230, the pin 10 is crimped in step S240. Then, the pin 10 that has been crimped in the deformation of step S240 is press-fitted into the first member 20 in step S250. In the press-fitting of step S250, the control unit 130 controls the rotation of the pin 10 about the central axis 13 when the second transport unit 121 transports the pin 10 so that the pin 10 tilts in a desired direction. This control is performed based on the design information (including, for example, information on a direction in which the second member 30 abuts) stored in the storage unit 140.

The second member 30 abuts on the pin 10 that is press-fitted into the hole of the first member 20 in the press-fitting step, thereby positioning the second member 30 with respect to the first member 20 in step S260. This positioning of step S260 may be performed after the press-fitting of a predetermined number of pins 10 is completed.

According to the present exemplary embodiment, the conditions for crimping are determined based on the measurement results, and therefore, it is possible to improve the possibility of press-fitting the pin 10 in a desired direction with a desired amount of tilt.

In the present exemplary embodiment, an example has been described in which the pin measurement unit 210 is placed at a position where the pin measurement unit 210 can detect the pin 10 held by the pin holding unit 113, and the hole measurement unit 220 is placed at a position where the hole measurement unit 220 can detect the hole provided in the first member 20 held by the member holding unit 122. However, the arrangement of the pin measurement unit 210 and the hole measurement unit 220 is not limited to this example. By detecting the pin 10 held in the pin holding unit 113 by the pin measurement unit 210, even when the pin 10 is not held correctly in the pin holding unit 113 but is held at an angle, for example, conditions for crimping can be determined according to the holding state.

Further, the shapes of the pin 10 and the hole may be measured externally to the pin press-fitting apparatus 200. In that case, information on the shapes of the pin 10 and the hole measured externally is stored in the storage unit 140, and the control unit 130 determines conditions for crimping based on the information stored in the storage unit 140.

In the present exemplary embodiment, an example has been described in which the conditions for crimping are determined using the measurement results of both the pin measurement unit 210 and the hole measurement unit 220. However, the measurement results of at least one of the pin measurement unit 210 and the hole measurement unit 220 (information on the shape of at least one pin) may be used.

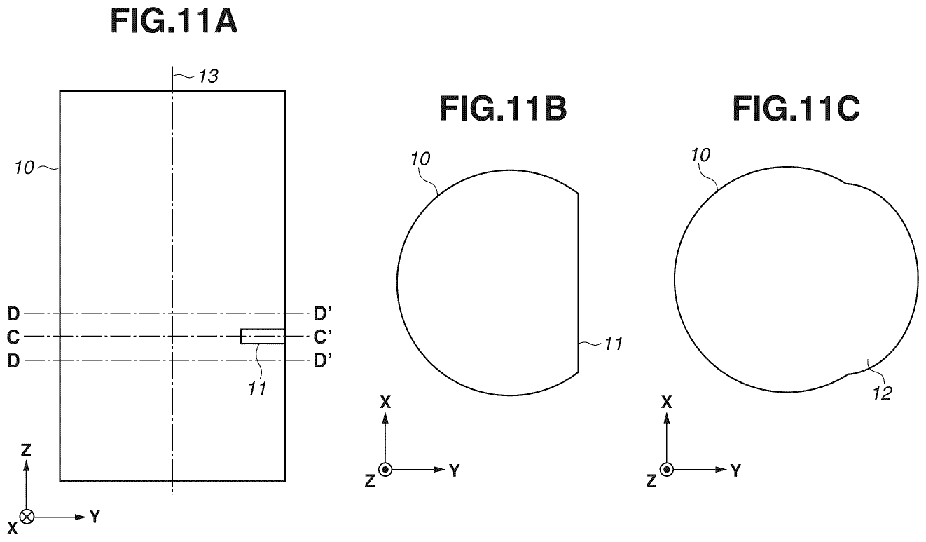

A third exemplary embodiment differs from the first exemplary embodiment in position where the pin 10 is crimped. FIGS. 11A, 11B, and 11C illustrate examples of a crimped pin 10 according to the present exemplary embodiment. In the present exemplary embodiment, the pin 10 is crimped using one tool instead of two tools, and the scratch 11 is made as illustrated in FIG. 11A. In this case, in a cross section C-C′, whose position in the Z-axis direction coincides with the position of the scratch 11, the place of the scratch 11 is recessed as illustrated in FIG. 11B. Then, in a cross section D-D′, where a position in the Z-axis direction deviates from the position of the scratch 11, regions 12 located on the +Z and −Z direction sides of the scratch 11 extension/bulge, as illustrated in FIG. 11C.

As described above, the regions 12 cause resistance when the pin 10 is press-fitted into the first member 20. In the present exemplary embodiment, as in the first exemplary embodiment, the tilt direction and amount of tilt of the pin 10 can be set to a desired state by adjusting conditions including the position at which the pin 10 is crimped (Y-axis direction, Z-axis direction), the angle of the tool for crimping, and the strength of force for crimping.

A fourth exemplary embodiment differs from the first exemplary embodiment in method of determining conditions for crimping. In the present exemplary embodiment, a determination step for determining conditions for crimping is not performed, and instead, the pin 10 is crimped under fixed conditions. At this time, as illustrated in FIG. 4A, the first tool 116a and the second tool 116b crimp the pin 10 while making scratches 11 on the pin 10, centered at a position deviating from the central axis 13 of the pin 10. That is, the pin 10 is crimped so that the center positions in the longitudinal direction of the regions where the pin 10 is to be deformed deviate from the positions where the diameter of the pin 10 is maximum before the pin 10 is deformed. In other words, the pin 10 is crimped so that the center positions in the longitudinal direction of the regions where the pin 10 is to be deformed are closer to the side on which the second member 30 abuts than the central axis 13 of the pin 10 is.

Then, the control unit 130 controls the second transport unit (press-fitting unit) 121 to adjust the position and angle of the pin 10 when the pin 10 is press-fitted into the first member 20 so that the pin 10 tilts in a desired direction. That is, the second transport unit (press-fitting unit) 121 is controlled (adjusted) so that the center positions in the longitudinal direction of the deformed regions of the pin 10 are closer to the side on which the second member 30 abuts than the central axis 13 of the pin 10 is. That is, when abutting the second member, a center position of the deformed region is closer to the second member than to a central axis of the pin. More preferably, the control unit 130 controls the second transport unit (press-fitting unit) 121 to adjust the position and angle of the pin 10 when the pin 10 is press-fitted into the first member 20 so that the pin 10 tilts at a desired amount of tilt. This adjustment may be made based on design information stored in the storage unit 140 (including, for example, information on a direction in which the second member 30 abuts) or based on condition information input in advance by the user and stored in the storage unit 140.

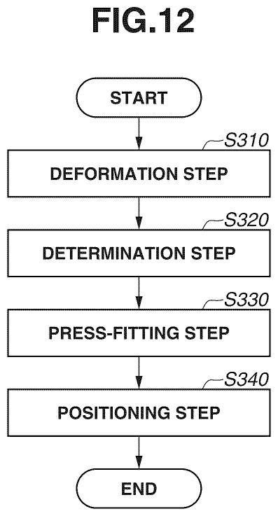

FIG. 12 is a flowchart of positioning the second member 30 with respect to the first member 20 by using the pin 10 according to the present exemplary embodiment. The pin 10 is crimped (deformed) in step S310. The control unit 130 determines conditions for press-fitting the pin 10 in step S320. This determination is made by determining, based on the direction in which the second member 30 abuts, conditions for achieving a desired tilt direction and a desired amount of tilt after the pin 10 is press-fitted into the first member 20. Examples of the conditions include the position and angle of the pin 10 when the pin 10 is press-fitted, in other words, the position and angle of the second transport unit 121. Such information is input by the user using, for example, an input device or a display device. The input device is a device for inputting characters and data, and includes various types of keyboards, mice, and touch panels.

The display device is a device for displaying information necessary for operations, processing results, and the like, and corresponds to a CRT or liquid crystal monitor. Alternatively, the information may be input from the user through communication from another information processing apparatus.

In step S330, the pin 10 is press-fitted into the first member 20 under the conditions determined in the determining of step S320). The second member 30 abuts on the pin 10 press-fitted into the hole of the first member 20 in the press-fitting of step S320, thereby positioning the second member 30 with respect to the first member 20 during positioning in step S340.

In the present exemplary embodiment, since the pin 10 is crimped under fixed conditions, there is no need to perform an adjustment step, and the time for crimping the pin 10 can be reduced.

A fifth exemplary embodiment relates to a method for manufacturing an article, in which the article is manufactured by using the above-described method for processing the pin 10.

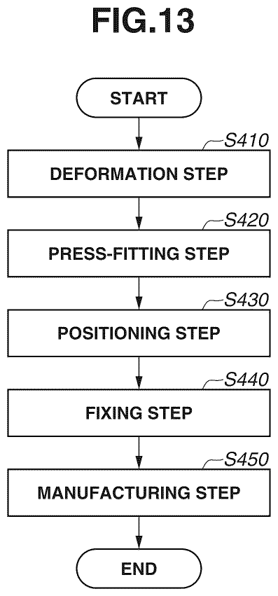

FIG. 13 is a flowchart of a method for manufacturing an article according to the present exemplary embodiment. Deformation is performed to deform the pin 10 in step S410. In step S420, a press-fitting is performed in which the pin 10 deformed in the deformation step is press-fitted into a hole provided in the first member 20. In step S430, positioning is performed in which the second member 30 abuts on the pin 10 press-fitted in the press-fitting of step S420, thereby positioning the second member 30 with respect to the first member 20.

In step S440, fixing is performed in which the first member 20 and the second member 30 are fixed together to form a third member including the first member 20 and the second member 30. In step S450, manufacturing is performed to manufacture an article including the third member processed in the fixing in step S440).

Here, the center positions in the longitudinal direction of the regions where the pin 10 are deformed in the deformation step are closer to the side on which the second member 30 abuts than the central axis 13 of the pin 10 is. According to the present manufacturing method, an article can be manufactured with higher accuracy of positioning the second member 30 with respect to the first member 20 than in the conventional techniques.

The present disclosure is not limited to the above-described exemplary embodiments, and various changes and modifications can be made without departing from the spirit and scope of the disclosure. Accordingly, the following claims are appended to apprise the public of the scope of the disclosure.

According to the present disclosure, it is possible to provide a positioning method capable of improving the positioning accuracy of a second member with respect to a first member by tilting a pin in a desired direction.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-018442, filed Feb. 9, 2024, which is hereby incorporated by reference herein in its entirety.

What is claimed is:

1. A method for positioning a second member with respect to a first member, the method comprising:
deforming a pin to form an indentation;
press-fitting the deformed pin into a hole in the first member; and
abutting the second member against the pin,
wherein, when abutting the second member, a center position of a deformed area of the pin is closer to the second member than to a central axis of the pin.

2. The method according to claim 1, wherein the press-fitting corresponds to a direction in which the second member is to abut the pin.

3. The method according to claim 1, further comprising determining conditions for deforming the pin.

4. The method according to claim 3,
wherein the determining is performed based on at least one of design information, information input by a user, a shape of the pin, and a shape of the hole.

5. The method according to claim 3,
wherein the conditions include at least one of a position of the pin while deforming, a position of a tool utilized to deform the pin, an angle of the tool relative to the pin, and an amount of force used to deform the pin.

6. The method according to claim 3,
adjusting the conditions for deforming the pin,
wherein the adjusting includes adjusting at least one of a position of the pin, a position of a tool utilized to deform the pin, an angle of the tool relative to the pin, and a setting of the tool.

7. The method according to claim 1, wherein in the deforming and the press-fitting, the pin is held by a same holding unit.

8. An apparatus for press-fitting a pin configured to abut a second member, the press-fitting apparatus comprising:
a holding unit configured to hold the pin;
a tool configured to deform the pin held by the holding unit; and
a press-fitting unit configured to press-fit the deformed pin into a hole provided in a first member,
wherein the hole is provided in the first member for positioning the second member with respect to the first member, and
wherein, when abutting the second member, a center position of a deformed area of the pin by force applied by the tool is closer to the second member than to a central axis of the pin.

9. The apparatus according to claim 8, further comprising:
a control unit configured to control at least one of a position of the pin, a position of the tool, and a force for driving the tool; and
a pin measurement unit configured to measure a shape of the pin,
wherein the tool is configured to deform the pin based on a measurement result of the pin measurement unit.

10. The apparatus according to claim 8, further comprising:
a control unit configured to control at least one of a position of the pin, a position of the tool, and a force to drive the tool; and
a hole measurement unit configured to measure a shape of the hole,
wherein the tool is configured to deform the pin based on a measurement result of the hole measurement unit.

11. The apparatus according to claim 8, further comprising:
a control unit configured to control at least one of a position of the pin, a position of the tool, and a force to drive the tool; and
a storage unit configured to store shape information of at least one of the pin and the hole,
wherein the control unit is configured to control deformation of the pin using the tool based on the shape information stored in the storage unit.

12. The apparatus according to claim 8, wherein, to press-fit the pin, the press-fitting unit adjusts a position of the pin according to a direction in which the second member abuts the first member and a position of a region where the pin is deformed.

13. An apparatus for press-fitting a pin configured to abut a second member, the press-fitting apparatus comprising:
a press-fitting unit configured to press-fit a region of the pin into a hole provided in a first member for positioning the second member with respect to the first member, with the region being deformed before the press-fitting; and
a control unit configured to control the press-fitting unit,
wherein, when abutting the second member, a diameter of the pin at a center position of the region is less than a diameter of the pin at the center position before the pin is deformed, and
wherein the control unit is further configured to control the press-fitting unit to align the center position of the region closer to the second member than a central axis of the pin.

14. A method for processing a pin configured to abut a second member, the pin being configured to be press-fitted into a hole provided in a first member to position the second member with respect to the first member, the method comprising:
deforming the pin,
wherein, when the second member abuts the first member, a center position of a deformed area of the pin is closer to the second member than to a central axis of the pin.

15. An exposure apparatus comprising:
a first member; and
a second member,
wherein the second member is configured to contact a pin press-fitted into a hole provided in the first member,
wherein the pin includes a bulged region, and
wherein, when the second member abuts the first member, a center position of the bulged region is closer to the second member than to a central axis of the pin.

16. An article manufacturing method comprising:
deforming a pin;
press-fitting the deformed pin into a hole provided in a first member;
positioning a second member with respect to the first member by abutting the second member against the press-fitted pin; and
forming a third member by fixing the first member and the second member,
wherein the manufactured article includes the third member,
wherein, when abutting the second member, a center position of a deformed area of the pin is closer to the second member than to a central axis of the pin.
